(19) United States
(12) Patent Application Publication
(10) Pub. No.: US 2014/0373739 A1
(43) Pub. Date: Dec. 25, 2014

(54) EMBODIMENT PROVIDING ENERGY SAVING IN HYDRAULIC BENDING PRESSES

(71) Applicant: Suat DEMIRER, Ankara (TR)

(72) Inventor: Suat DEMIRER, Ankara (TR)

(73) Assignee: DEMIRER TEKNOLOJIK SISTEMLER SANAYI TICARET LIMITE SIRKETI, Ankara (TR)

(21) Appl. No.: 14/314,194

(22) Filed: Jun. 25, 2014

Related U.S. Application Data
(63) Continuation-in-part of application No. 13/390,611, filed on Feb. 15, 2012, now abandoned.

(30) Foreign Application Priority Data
Aug. 18, 2009 (TR) 2009/06352

(51) Int. Cl. B30B 15/00; B30B 1/00

(52) U.S. Cl. CPC B30B 15/0052; B30B 1/00
USPC 100/269.14

(57) ABSTRACT

The invention relates to bending presses containing pistons providing up and down motion of an upper clamp, two servo motors for motion of the pistons, valves providing pre-filling during quick down and up motion of the pistons wherein upon driving of the four quadrant pumps by the servo motors, the four quadrant pumps rotate in descending direction and the upper clamp is moved downward and the servo motors rotate in reverse direction because of the weight of the upper clamp and the four quadrant pumps generate energy when servo motors are rotating on counter clockwise via kinetic energy that produced by ram weight, gravity and stroke distance of cylinder on press brake.

### CROSS-REFERENCE TO RELATED APPLICATIONS

The present application is a continuation-in-part of U.S. application Ser. No. 13/390611, filed on Feb. 15, 2012, and entitled “Energy Saving in Hydraulic Bending Presses”, presently pending.

### STATEMENT REGARDING FEDERALLY SPONSORED RESEARCH OR DEVELOPMENT

Not applicable.

NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The invention relates to an embodiment allowing operation at bending press machines providing bending and shaping the work materials by applying press on sheet materials of metal type by means of conduct of metal bending at less energy consumption, less oil use, more accurate down-up motions and less sound level.

The said invention relates to bending press integrated with two four quadrant pumps transmitting the driving received from the servo motor to pistons with variable recycling, fixed displacement, at least one pilot command system accumulating the energy generated during pressing to the places requiring pressure such as the said filling valves, safety valves.

2. Description of Related Art Including Information Disclosed Under 37 CFR 1.97 and 37 CFR 1.98.

In the system commonly applied in the related art, the electrical servo motor constantly rotates to supply oil to the system regardless of performance of work. This operation causes energy consumption and non-required oil heating even when machine does not perform work. In addition, proportional direction control valves used to maintain the parallel position during up and down motions of the bending form (matrix), speed adjustment valves, and other valves for quick and slow motions are used and they operate by controlling through an electronic circuit. These valves of several number used in the system cause pressure loss at several points. Because these valves are frequently turned down for accuracy of the motion (that is parallel position). During turning down operation both sound level increases and big amount of pressure loss occurs. The oil in the system heats because of pressure losses and the viscosity of the oil changes when the oil heats, and the setting made on the electronic card starts to fail to respond accurately as required. In other words, it gets difficult to maintain parallel position because of change in feature of oil. Moreover, coolers and big amount of oil is used to balance the heat increase in the systems as required. And this causes oil waste.

FIG. 3 and FIG. 4 are given in order to provide understanding of operating principle of our invention and energy producing via reverse directional movement of servo motor thanks to four quadrant pump. Any limiting effect should not take in consideration.

FIG. 3 shows bidirectional pump operating principle belongs to prior art and FIG. 4 shows four quadrant pump operating principle belongs to our invention. Bidirectional pump in FIG. 3, consumes energy in order to rotate the pump to both side. Also it consumes energy both raising and lowering the cylinder (piston). In FIG. 4 four quadrant pump consumes energy just for rising the cylinder (piston). Cylinder applies a pressure to four quadrant pump thanks to gravity, cylinder weight and effect of cylinder height necessity for lowering the cylinder in case of necessity for lowering the cylinder and the four quadrant pump transmits a eversion movement to servo motor. Transmitted reverse directional (counterclockwise) movement provides energy producing via downward (free fall) movement of cylinder thanks to feature of servo motor which provides generator like using and by this means energy recuperation is obtained.

When searching patents related with prior art, a patent application is encountered. The application numbered U.S. Pat. No. 5,568,766 describes deep drawing press. Before making a detailed explanation understanding of four quadrant pump and bidirecitonal pump terms, is a necessity to apprehend the issue better. Abkant presses are press machines that are using on plate production. They are used with specific angles in order to mould a plate. Generally they are used on bending operation on various profiles of plates that have thick and slim sequences. Also it is possible to make cylindrical bending operations thereby making special moulds. These presses give form to plates with bending operation.

As for spinning in other words deep drawing presses are formalizes the plates that have different thicknesses and different material characteristics (such as stainless steel, alloyed plate etc.) thanks to high pressing force between two mould as male and female mould. These machines formalizes the material by means of making plastic deformation of positioned material.

When considered above mentioned explainings of abkant presses and deep drawing presses, these two products are totally different from each other as of their working principles and their works. Both of them are press machines but working principles and formative products are totally different from each other.

Structure mentioned described in the application numbered U.S. Pat. No. 5,568,766 is not an abkant press structure. Aforementioned press structure in this document is a deep drawing press. Also there are many pumps and motors used on each axis on aforementioned patent with U.S. Pat. No. 5,568,766 number. When the figures that you specified as similar are examined it is seen that there are 6 pieces of pump and 4 pieces of motor are used on this patent. This situation causes too much costs and similar problems.

As can be seen in the FIG. 1 of the application numbered U.S. Pat. No. 5,568,766, the system described in our patent application practices this work with less pump and motor.

On the other hand energy recuperation is possible in our system thanks to generator function of servo motor when it is rotating on counter clockwise via kinetic energy that produced by ram weight, gravity and stroke distance of cylinder on press brake.

In our patent demand energy consumption just occurs while ram of press brake raising upward by this means a far amount of energy recuperation provided by way of lowering ram.

In order to set an example for lay emphasis on technique of our patent application, we assume that press operating life as 10,000,000 cycle and by means of our technique 10 Watt electric recuperation can be saved arising from each lowering of press ram presumptively and thus energy recuperation can be provided as 10,000,000×10 Watt=100,000,000 Watt in other words, 100,000 kW/press life. It is obvious that one skilled in the art cannot present a same or a similar invention to our invention associated with our patent.

We indicate again, in our method, engines rotate in reverse direction cause of weight of upper clamp. Thus, energy recovery is provided.

The solutions of Otremba (U.S. Pat. No. 5,568,766), which is indicated as similar to our invention, are about “energy saving”. As mentioned above, Otremba related with “energy saving”. So, the solution “energy recovery can not be provided via Otremba.

In FIG. 5, Current Values under 135 ton and 3100 mm press brake are compared between conventional press brake and our invention. As it will be understood from the measurements, a system, which peaks via energy consumption %77 less than standard system, is provided thanks to our invention. When Otremba is reviewed and comparison made with conventional system, it will be seen that even the best construction provides %50 energy saving.

Generally, it is not possible to design a system without using pump, valve, flow adjustment valve, pre-filing valve etc., cause of working principle of hydraulic machines. Thus, systems will show similarity. The characteristic and the novelty of the invention is; generating energy via weight of bending form and providing high energy efficiency via reuse of said energy. A system as described in our invention, which provides said solution, can not be produced without using the present components.

When searching patents related to bending presses, some patent applications were seen. Among them is patent application numbered EP02791546 filed by WILSON TOOL INTERNATIONAL, INC. on 2002 Jul. 26. The Abstract part of the invention reads as “the invention is a holder intended for mounting to bending press form containing a mounting support and it is characterized in that it consists of a body having support plate of the holder press and a clamp having upper and lower part and connected between lower and upper parts of the body in rotating position and a liquid inlet point allowing compressing the mounting support of the form between lower part and support plate of the clamp, a hole to provide compressed liquid to a place in the hole, a spindle containing a longitudinal eccentric surface allowing sliding in the hole in respect to providing liquid under pressure into the hole, a primary region of a bigger thread diameter in comparison to a secondary outer small diameter region of eccentric surface, motion of body against axial movement of the spindle in order to force the clamp to rotate in respect to the body and containing a pushing roller capable to connect to eccentric surface and thus driving the lower part of the clamp to support plate or a distance farther than it and compressing or opening of the mounting support of the form.

Another application is the patent application numbered EP 1741501 and dated on 2006 Jul. 5. The abstract part of the invention reads as “the invention relates to security device for a production unit for bending a sheet metal component, in particular for a bending press, with a stationary table beam and with a press beam which can be moved linearly relative to the table beam in a guide system by means of a drive mechanism, and with bending tools disposed in tool holders on oppositely lying end faces of the table beam and press beam forming an operating region between mutually facing forming regions, and with a light beam emitter and receiver system monitoring the operating region for ingress by a foreign body, where the bending tool disposed in the press beam is provided in the form of a lamella packet comprising at least one reference lamella and at least one tool lamella which can be displaced relative to it, which tool lamella is provided with cut-outs extending through it in the direction of a thickness which when aligned, form a beam passage for a light beam, in particular a laser beam, extending parallel with the end face of the press beam.

### BRIEF SUMMARY OF THE INVENTION

Differently from the existing related art, the purpose of the invention is that it contains technical features different from the bending press in the related and art provides a new solution. For instance, the servo motor only operates while performing work and thus energy consumption is prevented when not required.

One purpose of the invention is to provide motions of the bending form (matrix) for bending operation of the press in hydraulic system by work members such as four quadrant pump, servo motor, valve and cylinder. Some of those members are eliminated and some are amended and thus pressing, that is metal bending operation is conducted by use of less energy, less oil, more accurate down up motions and less sound level.

Another purpose of the invention is to provide characteristic allowing operation without need for work members such as direction control valve, flow adjustment valve, pressure adjustment valve. Thus pressure losses are minimized to a level nearly none, the heating of oil is prevented and thus amount of oil is decreased, sound level is reduced and also energy loss is minimized. For instance, saving up to 60% has been provided.

A further purpose of the invention is to change the four quadrant pump type used widely in the systems and to use four quadrant pump capable to rotate in both directions (variable recycling), to provide driving by control of servo motor rotation of the four quadrant pump with hydraulic position control, and thus allow adjustment of pressure even in static position.

Another purpose of the invention is to perform the duties of valves by help of feature of four quadrant pump ending in no need for valves for position setting. Up or down movement of the work member (cylinder) in the system is provided by right or left rotation of the four quadrant pump instead of direction control valve. Valves such as flow control valve, pressure setting valve are not needed by help of speed control of the servo motor.

A further purpose of the invention is to decrease the amount of oil used in the system since there is no need for flow control and pressure setting valves and therefore elimination of viscosity change of the oil by conversion of energy into heat during turning down operations when such valves are used. Furthermore, the new system used in the four quadrant pump generates additional energy by re-gaining energy generated during down motion of the press by use of weight of the bending form (matrix).

A different purpose of the invention is to eliminate the need for electronic card adjustment for each valve arising from sliding embodiments in the valves as the hydraulic proportional valves are eliminated. And this eliminates the time loss arising from separate adjustments during serial manufacturing and thus provides contribution in increase of production. Since the system consists of simple members, the service costs are also kept at minimum.

The invention provides both energy saving and energy recuperation thanks to variable speed motor and four quadrant pump (pump-motor). Energy saving provided by bidirectional hydraulic pumps in other words two way pump (clockwise and counterclockwise) by means of variable speed motor. But aforementioned systems does not appropriate for energy recuperation. In the said system, bidirectional pump consumes energy while both lowering and raising of weight (ram/upper clamp). But four quadrant pump operates like a motor when it lowering the weight and produces energy by means of using generator feature of servo motor thanks to function of servo motor that four quadrant pump is mounted. That is to say kinetic energy that resulting from gravity is transformed into potential energy.

In order to achieve the above mentioned purposes, bending presses is improved which contains pistons providing up and down motion of upper clamp, two servo motors for motion of the said pistons, valves providing pre-filling during quick down and up motion of the pistons wherein upon driving of the four quadrant pumps by servo motors (50), the four quadrant pumps rotate in descending direction and upper clamp is moved downward and servo motors rotate in reverse direction cause of weight of upper clamp and said four quadrant pumps generates energy when servo motors are rotating on counter clockwise via kinetic energy that produced by ram weight, gravity and stroke distance of cylinder on press brake.

### BRIEF DESCRIPTION OF THE SEVERAL VIEWS OF THE DRAWINGS

In order to make the embodiment and additional members being subject of the present invention as well as the advantages clearer for better understanding, it should be assessed with reference to the fallowing described figures.

FIG. 1 is a perspective view of new hydraulic system together machine integrated with bending press machine being subject of the invention.

FIG. 2 is a two dimension schematic view indicating the hydraulic system being subject of the invention. “A detail” is given to show close-up view of four quadrant pump symbol.

FIG. 3 shows, operating principle of bidirectional bump belongs to prior art.

FIG. 4 shows, operating principle of four quadrant pump being subject of the invention.

FIG. 5 shows comparison of Current Values under 135 ton and 3100 mm press brake between conventional press brake and our system being subject of the invention.

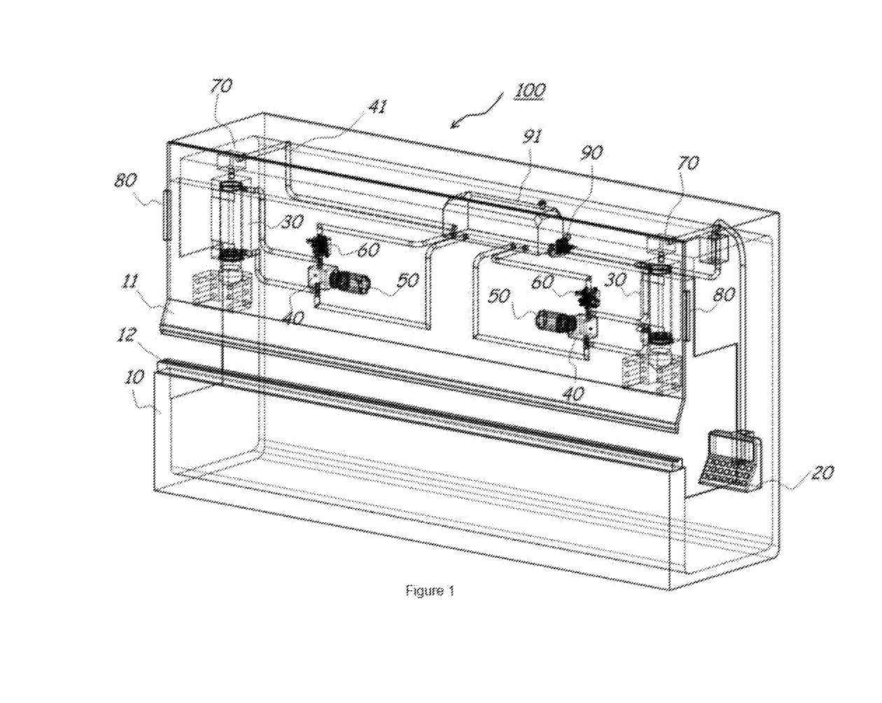

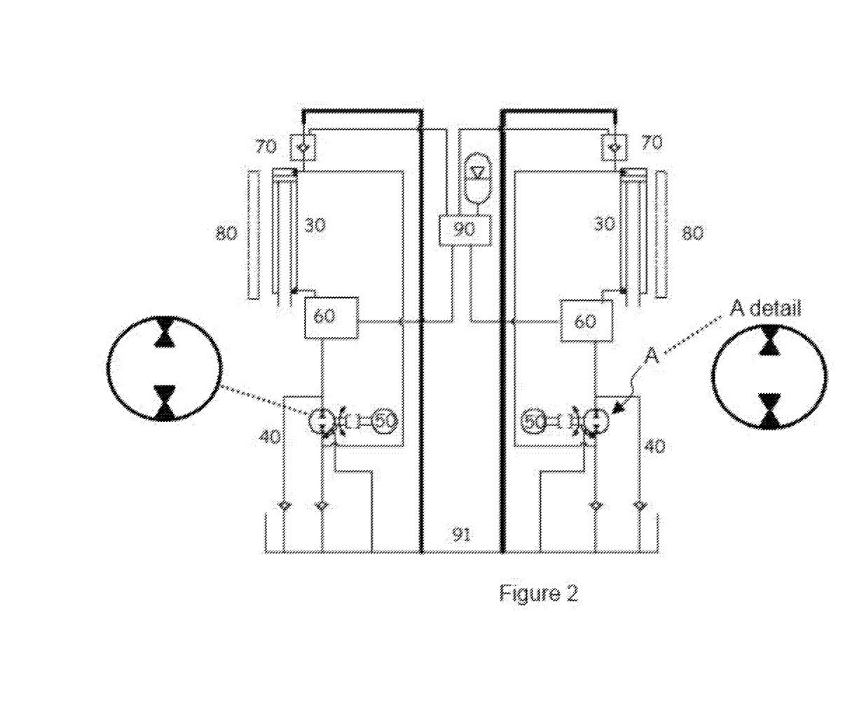

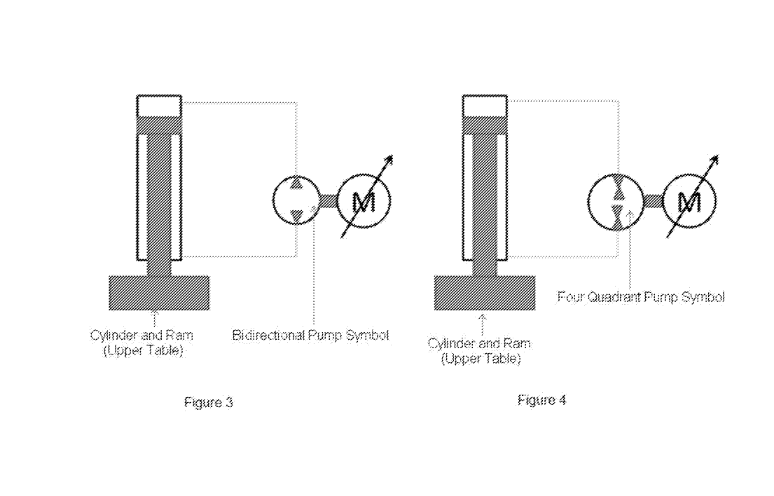

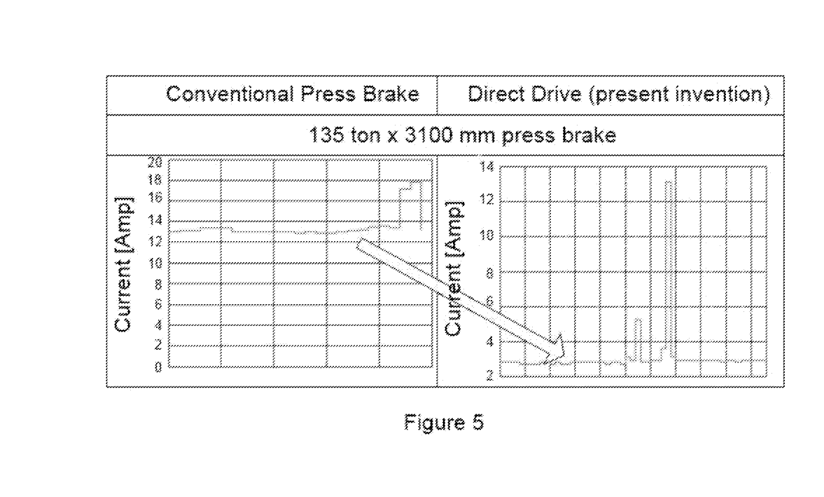

### REFERENCE NUMBERS

10 Machine body

11 Upper clamp

12 Lower clamp

20. Command unit

30 Pistons

40 Four Quadrant Pumps

41 Pipes

50 Servo motors

60 Safety valves

70 Filling valves

80 Position ruler

90 Pilot command valve block

91 Oil tank

100 Bending press

### DETAILED DESCRIPTION OF THE INVENTION

In this detailed description, the preferred embodiments of the bending press machine (100) being subject of this invention have been disclosed solely for the purpose of better understanding of the subject and described in a manner not causing any restrictive effect.

The invention is related bending presses (100) containing pistons (30) providing up and down motion of upper clamp (11), two servo motors (50) for motion of the said pistons (30), valves (70) providing pre-filling during quick down and up motion of the pistons (30) wherein upon driving of the four quadrant pumps (40) by servo motors (50), the four quadrant pumps (40) rotate in descending direction and upper clamp (11) is moved downward and servo motors (50) rotate in reverse direction cause of weight of upper clamp (11) and said four quadrant pumps (40) generates energy when servo motors (50) are rotating on counter clockwise via kinetic energy that produced by ram weight, gravity and stroke distance of cylinder on press brake.

In respect to components of existing state of art, the invention contains pistons (30) providing up and down motion of the upper clamp (11), two servo motors (50) for motion of the said pistons (30), valves (70) providing pre-filling during quick down and up motion of the pistons (30).

In respect to the inventive components of the said invention, it contains two four quadrant pumps (40) transmitting the driving received from the said servo motor (50) to pistons (30) with variable recycling, fixed displacement, at least one pilot command block (90) accumulating the energy generated during pressing and transmitting to the places requiring pressure such as the said filling valves (70), safety valves (60).

For start of motion of the pistons (30) adapted to the machine body (10), the pre-filling valves (70) are opened and the downward motion of the four quadrant pumps (40) driven by the servo motors (50) is started. Without damaging parallel position by use of signals fed from the rulers (80), downward motion continues. The energy generated due to weight of the mass during going down is converted into electric generation. This process continues at high speed until the bending form (matrix) arrives the material to be bended and generates energy. Slowing down is made at a safe distance, the operations are realized by the signals received from the position rulers (80) and the speed command of the servo motor (50).

Here the filling valves (70) are closed and pressing operation is started. Servo motor (50) speed is progressed at the revolving foreseen for pressing and the pressing operation is completed by the position data received from the rulers (80). The filling valves (70) are opened and upon opposite rotation of the servo motors (50) the upward motion of the pistons (30) is started. When the distance required for bending is taken, the filling valves (70) are closed and waiting position is started. Then the operation to be carried out will be re-started according to request of the user. All of those operations are carried out only by four quadrant pump (40) and right or left motions of the servo motors (50) without use of any direction control valve. These operations are carried out without use of valve other than the valve to perform locking for prevention of falling of the bending form (matrix) in case of cut of power required for filling valves (70) and CE.

Bending press (100) is C type press in terms of structure. Main body is formed by means of adding a vertical plate of 90 degrees angle to the two parallel C edges and this plate also performs the duty of carrying form body. The 2 cylinders perpendicular to the plate of the main body provides motion of the bending form (matrix) on a vertical block Y axis where it will be connected.

Some members in this system are changed and the press can be operated in the same logic. For that reason, it is possible to obtain more different embodiments by change of valve. For instance, pilot command valve block (90) can be operated by means of installing an electrical commanded valve instead of check valve.

In order to perform bending operation at bending press (100), a lower clamp (12) is located under the upper clamp (12). The system contains a command unit (20) for commanding it. It also contains an oil tank (91) to supply oil the hydraulic system and pipes (41) for distributing the oil to the valves (60-70) and pistons (30).

Process steps of the hydraulic system integrated to bending press (100) consists of
opening of the filling valves (60) upon start instruction given to the system,
rotation of four quadrant pumps (40) to descending direction upon driving of the four quadrant pumps (40) by servo motors (50), and downward movement of the bending form (matrix) (upper clamp (11),
closing of the filling valves (70) before slowing down of the bending form (matrix) at desired position at the ruler (80) and start of pressing operation,
conduct of accurate bending operation by the bending form (matrix) with the data to be sent to the servo motor (50) according to the position data received from the ruler (80),
after bending operation, while the servo motor (50) and four quadrant pump (40) rotate in reverse direction, opening of filling valves (70) and movement of the bending form (matrix) to the desired position by the pistons (30),
when the bending form (matrix) reaches its position, keeping all components at ready position without consuming any power.

The protection area of this application has been specified under claims and cannot be limited to the descriptions only given as sampling above. It is clear that any innovation can be provided by a person skilled in the related art by use of the similar embodiments and/or can also apply this embodiment in other areas for similar purposes used in the related art. Therefore, such embodiments will be lack of novelty and inventive step criteria.

1. Bending presses containing pistons providing up and down motion of upper clamp, two servo motors for motion of the said pistons, valves providing pre-filling during quick down and up motion of the pistons wherein
upon driving of the four quadrant pumps by the servo motors, the four quadrant pumps rotate in descending direction and the upper clamp is moved downward and the servo motors rotate in reverse direction cause of weight of upper clamp and,
said four quadrant pumps generate energy when the servo motors are rotating on counter clockwise via kinetic energy that produced by ram weight, gravity and stroke distance of cylinder on press brake.
